(19) United States
(12) Patent Application Publication
(10) Pub. No.: US 2008/0249194 A1
(43) Pub. Date: Oct. 9, 2008

(54) STABLE EMULSION AND PROCESS OF PREPARATION THEREOF

(75) Inventors: Philippe Tanguy, Outremont (CA); Louis Fradette, Blainville (CA); Charles-Olivier Fournier, Montreal (CA)

Correspondence Address: BERESKIN AND PARR, 40 KING STREET WEST, BOX 401, TORONTO, ON, M5H 3Y2, CA

(73) Assignee: CORPORATION DE L'ECOLE POLYTECHNIQUE DE MONTREAL, Montreal, QC (CA)

(21) Appl. No.: 12/062,290

(22) Filed: Apr. 3, 2008

Related U.S. Application Data
(60) Provisional application No. 60/910,047, filed on Apr. 4, 2007.

(51) Int. Cl. C08L 95/00; B01F 3/08

(52) U.S. Cl. 516/38; 516/53

(57) ABSTRACT

This document relates to a stable emulsion comprising a continuous phase and a dispersed phase comprising droplets. The droplets are at least partially covered with a powder and the powder comprises particles having an average size which is at least 10 times smaller than the average size of the droplets. A process for preparing the emulsion is also presented.

### CROSS-REFERENCE TO RELATED APPLICATIONS

The present application claims priority on U.S. Provisional Application No. 60/910,047 filed on Apr. 4, 2007. The above-mentioned application is incorporated herein by reference in its entirety.

### TECHNICAL FIELD

The present document relates to the technical field of physical chemistry and of emulsions. More particularly, this document relates to stable emulsions which may be used in several fields, such as, for example the oil industry.

### PRIOR ART

The present document relates to the technical field of physical chemistry and of emulsions. More particularly, this document relates to stable emulsions which may be used in several fields, such as, for example the oil industry.

Heavy oil is difficult to transport via pipeline due to its viscosity. This is mainly caused by a concentration of asphaltenes which exceeds the critical threshold from which the latter begin to form a network. The solutions proposed to date mainly consist in decreasing the viscosity of the heavy oil. One approach consists in lubricating the oil with water forming an annular flow.

Several commercial examples of the transport of heavy oil via a pipeline already exist. Notably, Petrobras™ has built a 14.8 km heated underground pipeline between the Fazenda Alegre wells and the marine terminal at Campo Grande. Having to transport heavy oil that is already hot, Enbridge™ built a 40 km insulated pipeline between the MacKay river wells and Fort McMurray, for a cost of 55 million dollars. A 38 km pipeline lubricated by a water loop has already been implemented by Shell™ near to Bakersfield in California. The Orimulsion™ process, sold by the Bitor™ subsidiary of Petroleos™ of Venezuela, is the only system for transporting heavy oil via an emulsion that is used commercially. The emulsion is not separated; it is instead burnt exclusively in thermal power plants. One method currently used is dilution, which consists in mixing the heavy oil with a light hydrocarbon. When the natural gas wells are close by, such as in several places in Alberta, the most commonly used diluent is the condensate of the natural gas, and this is only used once, and is sold as part of the oil. Otherwise, the solvent must be recycled, which involves the construction of a second countercurrent pipeline. Finally, one alternative to all these methods consists in directly pre-refining the heavy oil in order to separate it into light oil and into coke, and in sending the light oil alone into the pipeline, as is done by Syncrude™. Despite these proposed solutions, the desire to reduce the transport costs of the heavy oil arouses an enormous amount of interest.

There are several ways of reducing the viscosity of the heavy oil, some used commercially, others in development, and each has its advantages and its disadvantages. Transport via heated or insulated pipeline may be a good solution over short distances, but over long distances will be less economical than a solution which is only applied to the ends of the pipeline. Furthermore, it can be assumed that the heavier the oil is, the more it is necessary to keep it at a high temperature, which increases the costs for extra heavy oil. Dilution with a light hydrocarbon requires the construction of a second pipeline, which is expensive. The technique becomes advantageous when it is possible to use the condensate of a natural gas well that is close by, but then the choice of the properties of the diluent is limited. In addition, the oil production becomes dependent on the gas production, which is not practical. Just as for the heating, the costs increase the heavier the oil is, since it requires more diluent. Pre-refining is not really a solution, since there will still be a bit of transport to be done from the production site. Finally, some other avenues of research target a reduction in the viscosity, such as the idea of temporarily precipitating the asphaltenes, and also the use of the emulsan bacterium which produces a suitable surfactant. These solutions are however perhaps far from a possible commercialization.

It is also possible to transport heavy oil via a pipeline without reducing its viscosity, by preventing physical contact between the oil and the wall of the pipeline. The archetypal way of avoiding physical contact is annular flow: the oil forms the core of the flow and the water forms the periphery thereof and acts as a lubricant, giving a pressure drop similar to that of a flow of water. This technique is the only one which becomes more advantageous the heavier the oil is as, on the one hand, the more the density of the oil approaches that of water, the less it tends to rub against the top of the wall via flotation and, on the other hand, the less it forms undulations at the water/oil interface which could destabilize the flow, thus creating a water-in-oil emulsion. Compared to the transport of an emulsion, annular flow has the advantage of requiring less water and no additive. On the other hand, it poses serious problems during the stopping and restarting of the flow. Furthermore, the pumping is complex, since oil and water must be pressurized and injected separately. It can therefore be assumed that this technique loses any economic advantage with regard to the emulsions when the pipeline is sufficiently long to require several pumping stations.

In order to transport the heavy oil in the form of a low viscosity emulsion, a stable oil-in-water emulsion is generally required. The stabilization of such an emulsion is generally carried out by the addition of a chemical surfactant, and the formulation of novel surfactants constitutes a hot topic of scientific research in this field. The HLB method, which makes it possible to sort the surfactants according to their difference in affinity for the oil and water, arrived to facilitate the selection of surfactants towards the end of the 1940s. Other, more accurate parameters have subsequently been introduced, notably SAD, which measures the difference between the chemical potentials of the surfactant in water and in the oil, and which may be determined semi-empirically from quantities such as the salinity of the water, the temperature, and the number of certain groups in the molecular structure of the surfactant. The minimum stability and the moment of inversion normally correspond to SAD=0. Moreover, certain properties of an emulsion, such as the conductivity, stability, viscosity and size of the droplets, vary in a foreseeable manner as a function of the oil content and the SAD. Thus, the various steps of the preparation, of the transport and of the separation of an emulsion may be traced on a graph having the oil content on the X-axis and the SAD on the Y-axis in order to avoid (or to target) certain stability or viscosity zones. The model may be refined by varying the position of these zones as a function of parameters such as the surfactant concentration, the energy of the mixture, the suitable viscosity of the oil.

### SUMMARY OF THE INVENTION

One aspect relates to a stable emulsion comprising a continuous phase and a dispersed phase comprising droplets. The droplets are at least partially covered with a powder and the powder comprises particles having an average size which is at least 10 times smaller than the average size of the droplets.

The emulsion has the interesting advantage of not necessarily containing a surfactant that is soluble in one or other of the phases. The addition of a surfactant is therefore optional. It has been found that even in the absence of a surfactant, the emulsion has a stability over time that is particularly favorable for the transport via a pipeline. The absence of surfactants (substantially free of surfactant or contains essentially no surfactant) considerably limits the manufacturing costs and facilitates the subsequent rupture before the treatment of the oil. The fact that a solid material ensures the stability of the drops enables rupture processes to be set up that rely on mechanical methods, again that are not very expensive to put in place in view of the thermal methods that are generally and widely used.

Another aspect relates to a process for preparing an emulsion such as defined in the present document, the process being characterized in that:
wetting the powder with the liquid that forms the continuous phase of said emulsion; and
adding gradually the liquid that forms the dispersed phase of the emulsion while stirring in order to obtain said emulsion.

The average size of the droplets can be, for example, at least 100 μm, at least 250 μm, at least 300 μm, at least 400 μm, at least 500 μm, at least 750 μm, at least 1 mm, at least 2 mm, at least 5 mm or at least 1 cm. Alternatively, the average size of the droplets can be about 100 μm to about 1 cm, about 200 μm to about 1 cm, about 300 μm to about 1 cm, about 400 μm to about 1 cm, or about 500 μm to about 1 cm.

The emulsion can be an oil-in-water type emulsion. The continuous phase can comprise water, such as, for example tap water, purified water, deionized water, distilled water, a raw water or a production water. The dispersed phase can comprise a petroleum derivative. The dispersed phase can comprise oil such as for example crude oil, an emulsified bitumen, or an oil. It can also comprise a synthetic oil (such as, for example, a silicone oil) or a vegetable oil.

The powder (or solid) can be chosen from petroleum coke, clays, such as, for example bentonite and attapulgite, metallic powders, such as for example iron powder, and aluminas.

In the emulsion, the dispersed phase can have a concentration of less than 40 vol %. The concentration can also be about 1 to 30 vol %.

In the emulsion, the powder (or the solid) can have a concentration of less than 10 vol %. The concentration can also be about 0.1 to 5 vol % or else from 0.1 to 2 vol %.

The emulsion can also be of the water-in-oil type.

### BRIEF DESCRIPTION OF THE FIGURES

The present invention can be illustrated nonlimitingly in the examples which follow, in which:

FIG. 1 represents a photo of an emulsion according to one particular variant;

FIG. 2 represents a photo of an emulsion according to another particular variant;

FIG. 3 represents a photo of an emulsion according to another variant and more particularly drops of heavy oil that have been stabilized by very fine solids; and

FIG. 4 represents a photo of an emulsion according to another variant and more particularly drops of heavy oil that have been stabilized by very fine solids.

### DETAILED DESCRIPTION OF THE INVENTION

The following examples are given in order to better define that which has been previously presented in the present document and they should not be interpreted in a limiting manner.

### EXAMPLES

### Preparation of the Emulsions

The method for preparing emulsions stabilized by solids described here has been the subject of several tests and validations. It has made it possible to produce several emulsions from water (tap water, production water and distilled water), oils (diesel-type oil, for example VARSOL™ (light cut), heavy crude oil, vegetable oil (such as, for example, canola oil), and synthetic oil (such as, for example, silicone oil)) and solids (petroleum coke (petcoke), aluminas, and iron powders).

Here are some examples of powders or solids used, and also their specific surface area: Durmax™ aluminas (PM-153: 12 m²/g; PM-20: 10 m²/g; PM-8: 8 m²/g; UCV-30: 7 m²/g; SG-31: 2 m²/g; SG-27: 3 m²/g), 50 nm fine alumina (from 1000 to 2000 m²/g), Atomet™ 95 iron powder (0.7 m²/g), petcoke (900 to 1300 m²/g).

The method is described as follows:
Obtain a 1 to 5 vol % suspension of solids in water. The medium has to be turbulent enough to make it possible to maintain a uniform suspension and to rapidly cause the drops of oil to be covered by the particles in suspension. The higher the turbulence, the more rapid the rupture of the drops of oil will be without, however, ensuring that the covering, by the solid, of the surface generated will be better.
The oil is added as a trickle into the area furthest from the stirrer so that the trickle is broken into droplets before touching a metallic wall. If the oil is added in too large a quantity and too rapidly, it then agglomerates on the wall or on the stirrer and the emulsification becomes very difficult.
The stirring is maintained for the entire duration of the oil addition. The speed at the tip of the stirrer blade can be between 0.5 and 5 m/s. An oil concentration of the order of 40 vol % relative to the water can be achieved. The average size of the emulsion is a function of the stirring speed and of the viscosity of the oil involved. The typical sizes that have been observed, as a function of the conditions mentioned in the introduction, are about 100 microns to 5 mm. For example, the average sizes observed have been about 200 microns with petroleum oils that are not very viscous, 300 to 500 μm with vegetable oils and about 1 mm with heavy crude oils.
The emulsion is then left to “cream” in order to obtain an emulsion that is concentrated at the surface or at the bottom, depending on the solid used. The solid then at the water/oil interface represents from 0.05 to 1 wt % of the oil. The effective amount directly depends on the surface created, on the type of solid and on the average size of the latter.
Once the emulsion has been recovered, a second emulsion can be repeated in the same container and the same suspended solid since the amount of water withdrawn, just like the solid effectively used, is low.

| Continuous | Dispersed | Dispersed | % | | D_{solid} | D_{drops} |
|---|---|---|---|---|---|---|
| phase | phase | fraction | solid | Solid | (μm) | (μm) |
| Distilled | Solvent | 10% | 1% | Fe₂O₃ | 1 | <100 |
| Water | | | | | | |
| Process | Heavy | 20% | 1% | Fe | 100 | 2000 |
| Water | oil | | | | | |
| Tap water | Canola | 30% | 1% | Carbonyl | 5 | 300 |
| | oil | | | Fe | | |
| Distilled | Silicone | 20% | 1% | Fe | 30 | 500 |
| water | oil | | | | | |

D_{solid} = average size of the solid particles
D_{drops} = average size of the droplets of the dispersed phase

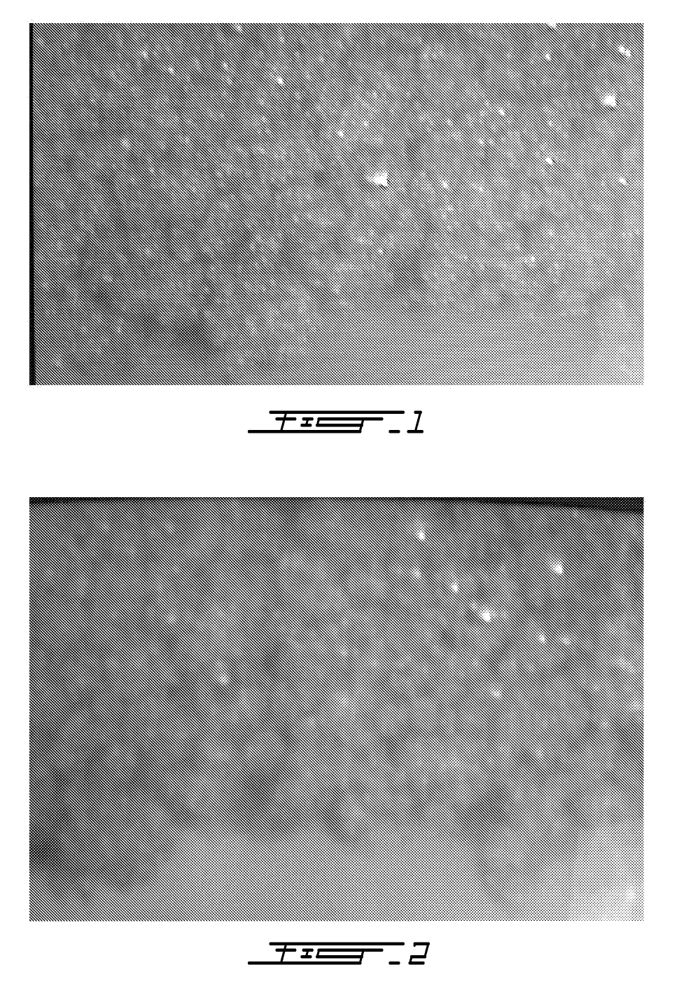

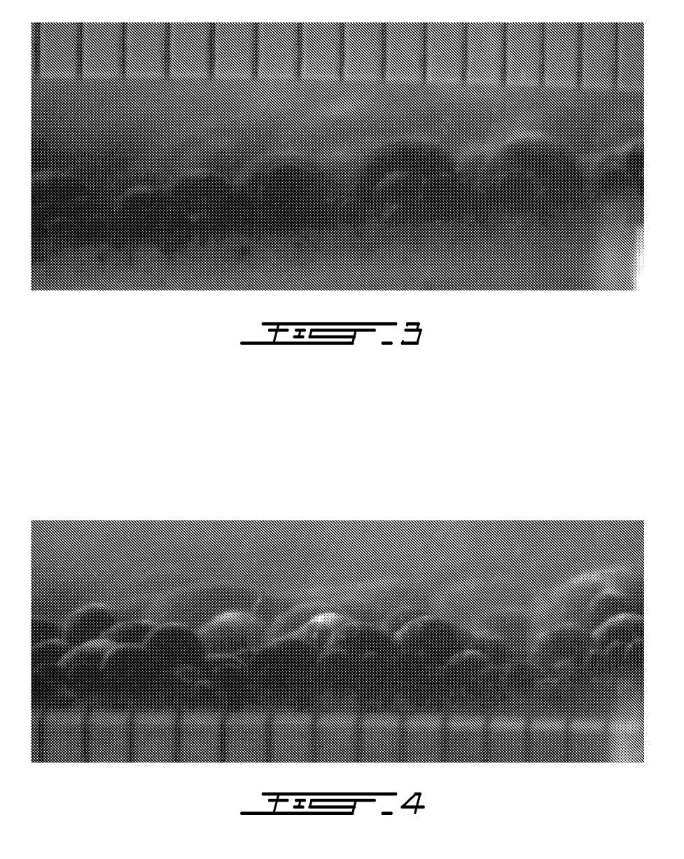

The photos (FIG. 1 and FIG. 2) show heavy oil Pickering emulsions produced by the method described here. The solid is petroleum coke extracted from a fluidized bed and whose average size is about 150 microns. Each visible sphere represents an individual drop of heavy crude oil whose interface is saturated with petcoke. The average size of the drops is very close to 1 mm. FIGS. 3 and 4 show drops of heavy oil that have been stabilized by very fine solids having an average diameter equal to 50 nm. The graduated reference is in mm. As for the preceding emulsions, the average size is very close to 1 mm.

Although the present document describes specific examples, it is understood that several variations and modifications can be incorporated into these examples, and the concepts presented in the present document aim to cover such modifications, usages or adaptations that include any variation of the present description which will become known or standard in the field of activity in which the various elements presented in the present document are located, in agreement with the scope of the following claims.

1. Stable emulsion comprising a continuous phase and a dispersed phase comprising droplets, said droplets being at least partially covered with a powder and said powder comprises particles having an average size which is at least 10 times smaller than the average size of said droplets.

2. Emulsion according to claim 1, in which the average size of the droplets is at least 250 μm.

3. Emulsion according to claim 1, in which the average size of the droplets is at least 500 μm.

4. Emulsion according to claim 1, in which the average size of the droplets is at least 1 mm.

5. Emulsion according to claim 1, in which the average size of the droplets is at least 5 mm.

6. Emulsion according to claim 1, in which the average size of the droplets is at least 1 cm.

7. Emulsion according to claim 1, in which the average size of the droplets is about 100 μm to about 1 cm.

8. Emulsion according to claim 1, wherein said emulsion is an oil-in-water type emulsion.

9. Emulsion according to claim 2, wherein said emulsion is an oil-in-water type emulsion.

10. Emulsion according to claim 1, wherein the continuous phase comprises water.

11. Emulsion according to claim 1, wherein the dispersed phase comprises crude oil, an emulsified bitumen, or an oil.

12. Emulsion according to claim 9, wherein the dispersed phase comprises crude oil, an emulsified bitumen, or an oil.

13. Emulsion according to claim 9, wherein the dispersed phase comprises a petroleum derivative.

14. Emulsion according to claim 1, wherein the powder is chosen from petroleum coke and clays.

15. Emulsion according to claim 12, wherein the powder is chosen from petroleum coke and clays.

16. Emulsion according to claim 1, wherein the powder is a clay chosen from bentonite and attapulgite.

17. Emulsion according to claim 12, wherein the powder is a clay chosen from bentonite and attapulgite.

18. Emulsion according to claim 12, wherein the dispersed phase is present in the emulsion at a concentration of less than 40 vol % relative to the volume of the continuous phase.

19. Emulsion according to claim 18, wherein the powder is present in the emulsion at a concentration of less than 10 vol % relative to the volume of the continuous phase.

20. Emulsion according to claim 1, wherein the emulsion contains essentially no surfactant.

21. Process for preparing an emulsion such as defined in claim 1, said process comprising:
wetting the powder with the liquid that forms the continuous phase of said emulsion; and
gradually adding the liquid that forms the dispersed phase of said emulsion while stirring in order to obtain said emulsion.

22. Process according to claim 21, wherein the stirring is carried out at a peripheral speed of a stirrer of about 0.5 to 5 m/s and wherein the oil is added sufficiently slowly in order to prevent the agglomeration of the latter on a wall of a reactor in which the process is carried out or on the stirrer.
